(19) United States
(12) Patent Application Publication
(10) Pub. No.: US 2006/0152190 A1
(43) Pub. Date: Jul. 13, 2006

(54) Wireless battery management system

(75) Inventor: Karl-Ragmar Riemschneider, Hamburg (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electrontics N.V., Eindhoven (NL)

(21) Appl. No.: 10/535,161

(22) PCT Filed: Nov. 5, 2003
(86) PCT No.: PCT/IB03/04929

§ 371 Date: May 16, 2005

(30) Foreign Application Priority Data
Nov. 15, 2002 (DE) 102 53 184.6

(51) Int. Cl. H02J 7/00

(52) U.S. Cl. 320/106

(57) ABSTRACT

Measurement of physical properties and individual charge control of the cells of a battery may lead to a longer battery life and to a more reliable operation. The present invention discloses a system, a cell unit, a control unit and a method for the automated management of batteries via a wireless communication link. According to the invention, the life cycle of individual cells of a battery may be tracked and recorded by an external control unit. Advantageously, active control of the battery cells is provided, including the ability to provide a short circuit between respective poles of battery cells.

The present invention relates to the field of battery management. More particularly, to an automated management of batteries, to a cell unit for measuring physical parameters of battery cells, to a control unit for receiving measured values of physical parameters of battery cells, and to a method for an automated management of batteries.

Batteries which are used for providing large quantities of electric energy often comprise a plurality of battery cells, the battery cells being electrically connected in a parallel or serial arrangement. Such large batteries may be part of a car engine or a ship's engine and used for starting the engine or providing electric energy, e.g. for maintaining a radio, a light or an electric heater.

Particularly in applications such as battery driven starters for engines, it may be of importance to be certain at all times that the battery will work correctly. Therefore, the user has to gain information about the charging condition of the battery. For batteries which comprise a plurality of individual battery cells, it may be of importance to gain knowledge about physical parameters concerning each single battery cell, for example, their individual charging condition, their individual filling level of electrolyte, or their individual temperature.

In a serial connection of a plurality of battery cells, the failure of a single battery cell, for example due to the corrosion of the electric contacts or to physical damage of the cell, may lead to the failure of the whole battery and thus to a malfunction of the system, the battery is intended to drive.

In order to minimize the risk of battery failure, the user may change the battery or the single cells of the battery on a regular basis; on the other hand, in order to operate the battery for as long as possible without risking battery failure, the condition of the cells of the battery has to be checked on a regular basis, or at least there has to be provided a system for establishing an electric short circuit between the electric poles of individual battery cells, in order to keep the whole battery working when a single battery cell causes a malfunction.

EP 0665568 relates to a cell by-pass switch, which can sense a battery cell failure and automatically provide an alternative path around the failing cell, thereby by-passing the failure and allowing the remaining battery system to continue its function. DE 3721754 discloses a short circuit element used for short circuiting single battery cells of a battery, for example, when they become high ohmic or due to a malfunction. Another system for providing an electric short circuit is disclosed in DE 695 03932.

It may not only be of importance to be able to by-pass individual cells of a battery in case of their malfunction, but also to measure the charging of each individual battery cell and to report the charging condition of each battery cell to an external control unit.

It is an object of the present invention to provide for a simple and cost efficient system for monitoring physical properties of the cells of a battery.

According to an exemplary embodiment of the present invention as set forth in claim 1, the above object maybe solved by a system for the automated management of batteries, wherein the batteries comprise at least one battery cell, and wherein the system comprises at least one cell unit, a control unit and a transmitter. The at least one cell unit may be used for measuring physical parameters of an individual battery cell or a group of battery cells. The transmitter may be used for transmitting the measured values of the physical parameters to the control unit. The measured values of the physical parameters may be transmitted via a first wireless communication link.

In other words, according to this exemplary embodiment of the present invention, physical properties of one or more battery cells of a battery are measured by the at least one cell unit and afterwards reported to the control unit, which may be located at a distance from the battery. Advantageously, according to this exemplary embodiment of the present invention, the measured values of the physical parameters are wirelessly transmitted to the control unit. The wireless transmission has the advantage that the control unit can be located far away from the battery and that no electric leads are necessary for connecting the at least one cell unit with the control unit, which may reduce the costs of the system.

According to another exemplary embodiment of the present invention as set forth in claim 2, the control unit comprises a control unit transmitter, which may be used for transmitting control signals to the at least one cell unit by means of a second wireless communication link.

Advantageously, according to this exemplary embodiment of the present invention, there is provided a system for not only measuring and reporting physical parameters of battery cells to an external control unit, but also for controlling the cell units externally from the control unit by means of a wireless communication link.

The physical properties of the battery cells measured by the cell units may comprise a voltage between poles of the battery cells, a time interval, in which the voltage between poles of the battery cells changes by a certain amount, a temperature of the electrodes or electrolyte of a battery cell, and a filling level of electrolyte solution or electrolyte density of the electrolyte of a battery cell. There are, of course, many more physical parameters which may be measured by the cell units, for example, the atmospheric pressure inside an individual battery cell, the gas concentration inside an individual battery cell, the color or the absorption coefficient of the electrolyte, and changes in the viscosity of the electrolyte.

According to another exemplary embodiment of the present invention as set forth in claim 3, the cell units comprise a switching unit, wherein the switching unit is adapted for temporarily establishing a controllable current path between poles of the at least one battery cell. Advantageously, by connecting the cell units to the electric poles of the battery cells, the cell units may be provided with electric energy from the battery cells. Additionally, establishing an electric contact between electric poles of the battery cells and the cell unit allows for the direct measurement of the voltage of the battery cells. Furthermore, the switching unit may be adapted to provide a short circuit between the poles of a defect battery cell.

According to another exemplary embodiment of the present invention as set forth in claim 4, the switching unit is adapted to perform a charge balancing such that the charging states of the plurality of battery cells are adjusted to each other. In other words, in case the battery drives an external consumer and the cell units detect a different charging state of the battery cells, a charge balancing between each battery cell may be performed, meaning that a battery cell with a lower charging state is disconnected from the external consumer or bypassed until it's charging reaches a mean charging value. This mean charging value may be the mean charging value of all battery cells of the battery.

According to another exemplary embodiment of the present invention as set forth in claim 5, the cell units are at least partially arranged in an interior region of the battery cells, in order to come into direct contact with the electrolytic solution of the battery cells. In order to prevent damage to the cell unit by the electrolyte, the chemically non-resistant materials of the cell unit may be surrounded by robust and chemically resistant materials. By this, an extended sensor of the cell unit may measure physical properties of the electrolyte, for example, its temperature or density.

According to another exemplary embodiment of the present invention as set forth in claim 6, a communication link between individual cell units or groups of cell units is established for direct communication with one another. This communication may occur without interference from the control unit. For example, individual cell units may compare measured values amongst each other or even process measured values. In addition, by direct communication with each other, individual cell units may even request data processing or measuring from other cell units without using the resources of the control unit. Therefore, no broadcasting of information has to take place between the cell units and the control unit, which saves both time and resources.

According to another exemplary embodiment of the present invention as set forth in claim 7, the at least one cell unit comprises electric leads. The electric leads comprise high frequency decouplers. Advantageously, the frequency decouplers may act as a low pass filter and may enable the electrical leads to be used as dipole antenna for receiving signals from the control unit or for transmitting signals to the control unit.

Furthermore, the frequency decouplers may be adapted to convert high frequency electromagnetic radiation into electric energy. Advantageously, the high frequency decouplers may receive electromagnetic waves, which may be transformed into electric energy. The electric energy may be used for driving the at least one cell unit.

Furthermore, the at least one cell unit may comprise a storage for storing electric energy. The stored electric energy may be used for charging individual battery cells or groups of battery cells. Furthermore, the at least one cell unit may comprise a controllable rectifier for controlling the charging of the at least one battery cell.

It should be understood that, according to an exemplary embodiment of the present invention, there is not only provided a system for measuring physical properties of individual battery cells and for reporting the measured values to a control unit, which may be located remote from the battery cells, but there may also be provided a system for actively controlling the charging of the individual battery cells from a distant location by the control unit via a wireless communication link.

It has to be noted that although the system for automated management of batteries, which will be described below in greater detail, controls the charging and functioning of batteries, and more particularly, the charging and functioning of individual battery cells, the same system may be used for controlling an array of solar cells or fuel cells.

According to another exemplary embodiment of the present invention as set forth in claim 8, a cell unit is provided for measuring physical parameters of battery cells, wherein the cell unit comprises a cell unit transmitter. The cell unit transmitter is used to transmit the measured values of the physical parameters by means of a wireless communication link. The cell unit may comprise a micro-chip for data processing and storage of measured values and processed data. By establishing a communication link between each other, individual cell units may communicate with one another and exchange data. For example, a cell unit may combine and process a plurality of measured values and send the combined and processed measured values to the control unit. Furthermore, by communicating with one another and by exchanging data, the data comprising measured values or combined and processed measured values, the cell units may be able to make decisions concerning the next steps to take in managing the battery cells without the help of the external control unit. This may save time and valuable resources of the control unit.

In order to save energy, the cell units may fall into a sleeping mode, when there is no need for them to process data, measure physical properties, or to transmit measured values.

According to another exemplary embodiment of the present invention as set forth in claim 9, a switching unit is provided, wherein the switching unit is adapted to perform a charge balancing such that the charging states of the plurality of battery cells are adjusted to each other.

According to another exemplary embodiment of the present invention as set forth in claim 10, the cell unit comprises electric leads, wherein the electric leads comprise high frequency decouplers. Advantageously, the frequency decouplers may act as a low pass filter and may enable the electrical leads to be used as dipole antenna for receiving signals from the control unit or for transmitting signals to the control unit. Furthermore, the frequency decouplers may be used for converting high frequency electromagnetic radiation into electric energy. Thus, it may be possible to drive the cell unit externally by sending electromagnetic waves of an appropriate frequency to the cell unit, which will then convert the electromagnetic waves into electric energy by means of the high frequency decouplers. Furthermore, the cell unit may comprise a storage for storing electric energy, which may be used to charge an individual battery cell. For example, a cell unit may extract energy from an individual battery cell and store that energy in the storage. In a second step, the cell unit may empty its storage into another battery cell and thus charge it. Following that, the cell unit may again extract electric energy from the first individual battery cell and, after that, again empty its storage into the second battery cell. This process may be repeated as long as it is useful. Furthermore, the cell unit may comprise a controllable rectifier for controlling the charging of the battery cells.

According to another exemplary embodiment of the present invention as set forth in claim 11, a control unit is provided which is adapted to receive measured values of physical parameters of battery cells and which is adapted for transmitting control signals to a cell unit. Both the measured values of the physical parameters of the battery cells and the control signals are transmitted by means of a first and second wireless communication link, respectively, such as a radio frequency transmission or an optical transmission. Transmitting information wirelessly has the advantage that the control unit may be located at a distance from the cell units and may even be carried around by a user. Moreover, wireless communication may be much cheaper than connecting each cell unit to the control unit by means of electric leads. Also, the wireless transmission may facilitate the installation of systems/units according to the present invention in already existing battery cell systems.

According to another exemplary embodiment of the present invention as set forth in claim 12, the control signals, which are transmitted from the control unit to the cell unit provide synchronization information. This synchronization information may be used to synchronize all the individual cell units, which are arranged in or adjacent to the battery cells.

According to another exemplary embodiment of the present invention as set forth in claim 13, the control unit addresses each cell unit individually and initiates the measurements of the physical parameters of the battery cells. Since, for energy saving purposes, the cell unit may be in a sleeping mode, the control unit may wake up the cell unit before initiating the measurement. Additionally, the control unit may request the transmission of measured values of the physical parameters. After receiving data from a cell unit, the control unit may process the received data, which may contain measured values of physical parameters, and transmit appropriate control signals to an individual cell unit. The control signals may comprise a request for establishing a short circuit between two poles of a battery cell. It should be noted that the unit cells may be addressed individually. The control unit may wake up a cell unit or request a measurement. Additionally, the control unit may ask a cell unit to transmit, calculate, or otherwise process its measured data. Upon receiving measured values or processed data from a cell unit, the control unit records the measured values or processed data of the cell unit in order to maintain a history of the life of individual battery cells. This history of life of the individual battery cells may be of particular interest for the user of the battery, for example, for predicting the life of individual battery cells.

According to another exemplary embodiment of the present invention as set forth in claim 14, a method is provided for automated management of batteries, wherein the batteries comprise at least one battery cell, and wherein the method comprises the steps of measuring physical parameters of at least one battery cell, by at least one cell unit and transmitting the measured values of the physical parameters via a first wireless communication link to a control unit.

Furthermore, according to another exemplary embodiment of the present invention as set forth in claim 15, individual control signals are transmitted from the control unit to the at least one cell unit of the battery via a second wireless communication link. The method according to the exemplary embodiment of the present invention provides for a charge control and life tracling means of the individual battery cells, which may be controlled by an external control unit, without the need for electric connections between the control unit and the at least one cell unit.

According to another exemplary embodiment of the present invention as set forth in claim 16, each cell unit measures the physical parameters of a respective group of battery cells, wherein the groups comprise at least one battery cell. According to this exemplary embodiment of the present invention, each battery cell belongs to at least two groups and the measured values of the physical parameters of particular groups may be subtracted from one another or otherwise processed in order to obtain physical parameters of individual battery cells. The subtraction of measured values or other processing steps may be carried out by an individual cell unit, which has established a communication link to other cell units, or by the control unit, to which the measured values of the physical parameters are transmitted via a wireless communication link.

According to another exemplary embodiment of the present invention as set forth in claim 17, a cell unit measures a density or a fill-level of electrolyte in the at least one battery cell by detecting a change in an emitted electromagnetic signal. The electromagnetic signal may be emitted by the cell unit itself or by some other device, for example, the control unit. Advantageously, the frequency of the emitted electromagnetic signal is in the same range as the frequency used for transmitting signals between the control unit and the cell unit, which means that no additional receiver electronic means are needed for the detection of a change in the emitted electromagnetic signal.

According to another exemplary embodiment of the present invention as set forth in claim 18, communication between the control unit and a cell unit or between individual cell units may be achieved by transmission of electromagnetic waves, inductive transmission, transmission of light, transmission of sound, or transmission of ac currents. It should be noted that the transmission of ac currents is not appropriate for communication between the control unit and a cell unit, since the communication between the control unit and a cell unit is established via a wireless communication link. The transmission of ac currents is, of course, suitable for communication between individual cell units.

According to another exemplary embodiment of the present invention as set forth in claim 19, the charge balancing is performed to adapt charges of a plurality of battery cells to each other by temporarily establishing a current path between poles of the plurality of battery cells.

It may be seen as the gist of an exemplary embodiment of the present invention that the charging of individual cell units of a battery is measured and controlled by an external control unit via a wireless communication link.

These and other aspects of the present invention will become apparent from and elucidated with reference to the embodiments described hereinafter.

Exemplary embodiments of the present invention will be described in the following, with reference to the following drawings:

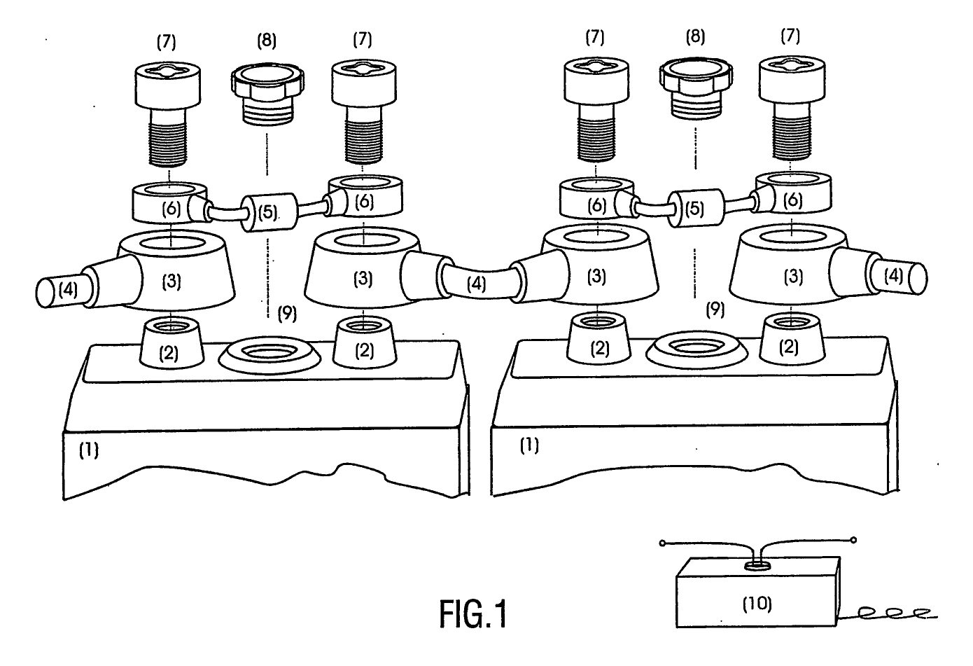

FIG. 1 shows a simplified schematic representation of the system for automated management of batteries according to an exemplary embodiment of the present invention.

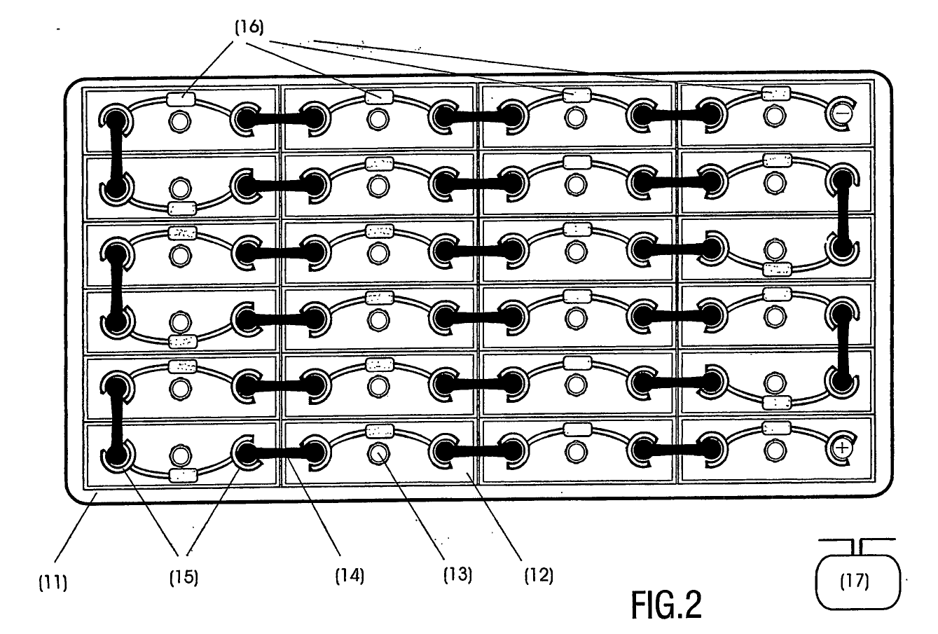

FIG. 2 shows a simplified schematic top view of the system for automated management of batteries according to an exemplary embodiment of the present invention.

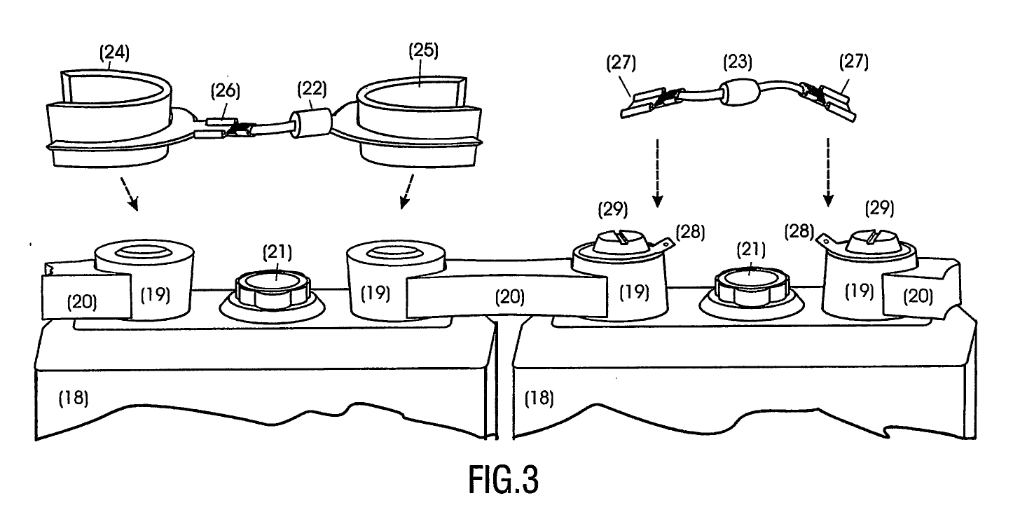

FIG. 3 shows a simplified schematic representation of two different cell units according to an exemplary embodiment of the present invention.

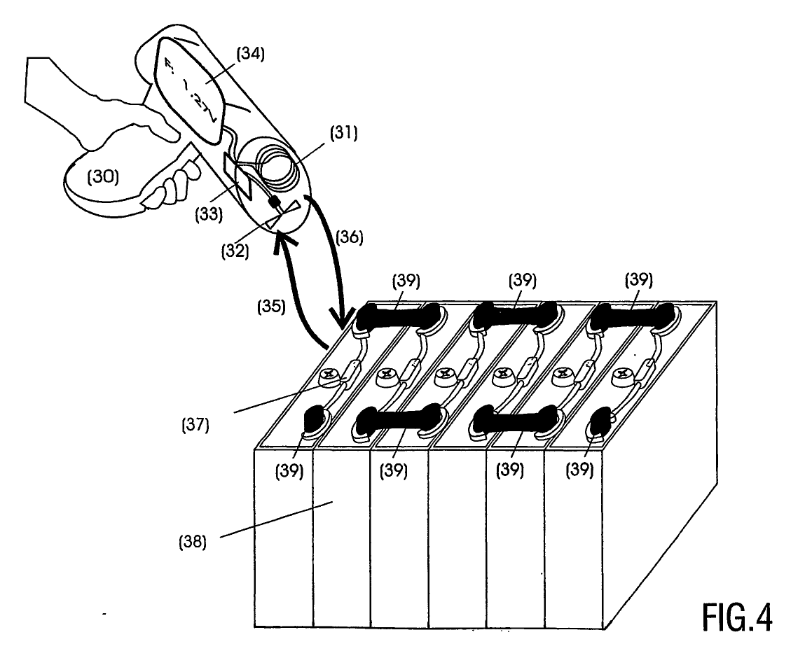

FIG. 4 shows a simplified schematic representation of a method according to an exemplary embodiment of the present invention.

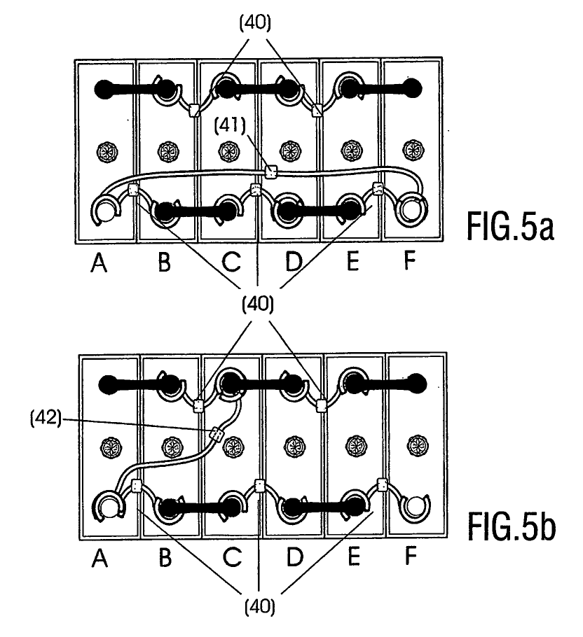

FIG. 5a shows a top view of a plurality of cell units connected to poles of a battery according to an exemplary embodiment of the present invention.

FIG. 5b shows a top view of a plurality of cell units connected to poles of a battery according to another exemplary embodiment of the present invention.

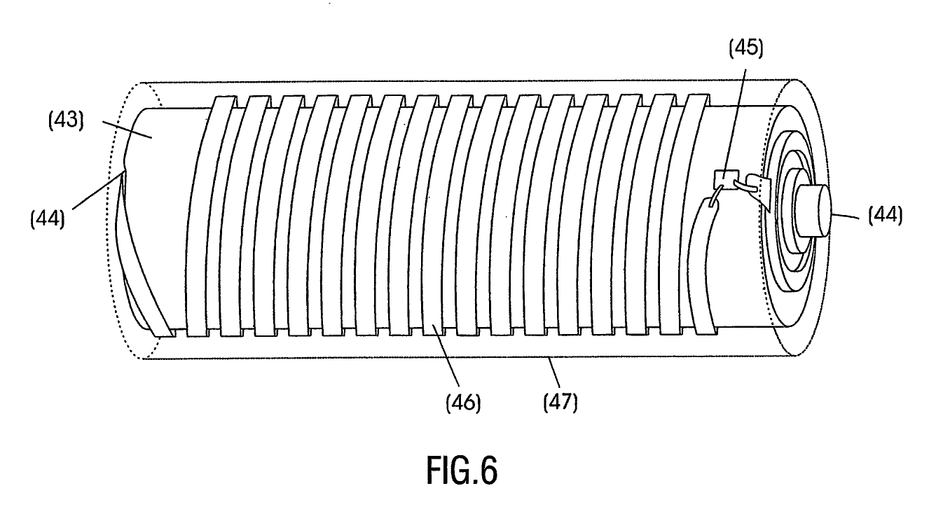

FIG. 6 shows a small battery, comprising a cylindrical cell and a respective antenna.

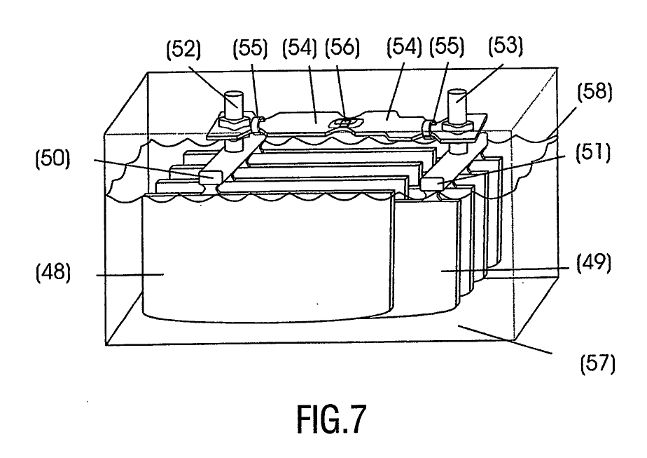

FIG. 7 shows an accumulator cell, comprising a cell unit according to an exemplary embodiment of the present invention.

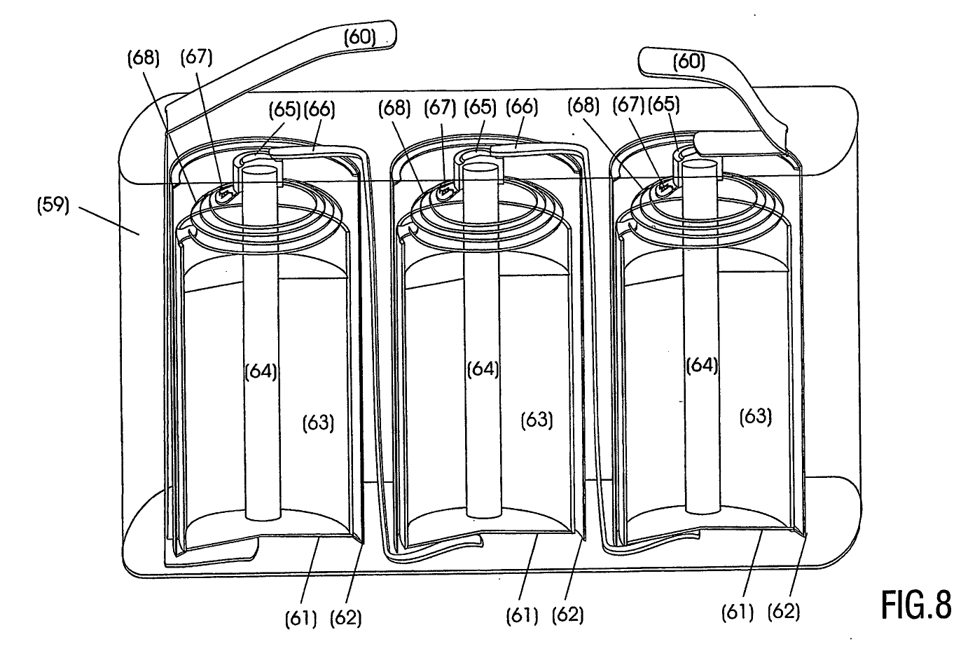

FIG. 8 shows a small battery, comprising a plurality of cylindrical cells, each cell comprising a cell unit according to an exemplary embodiment of the present invention.

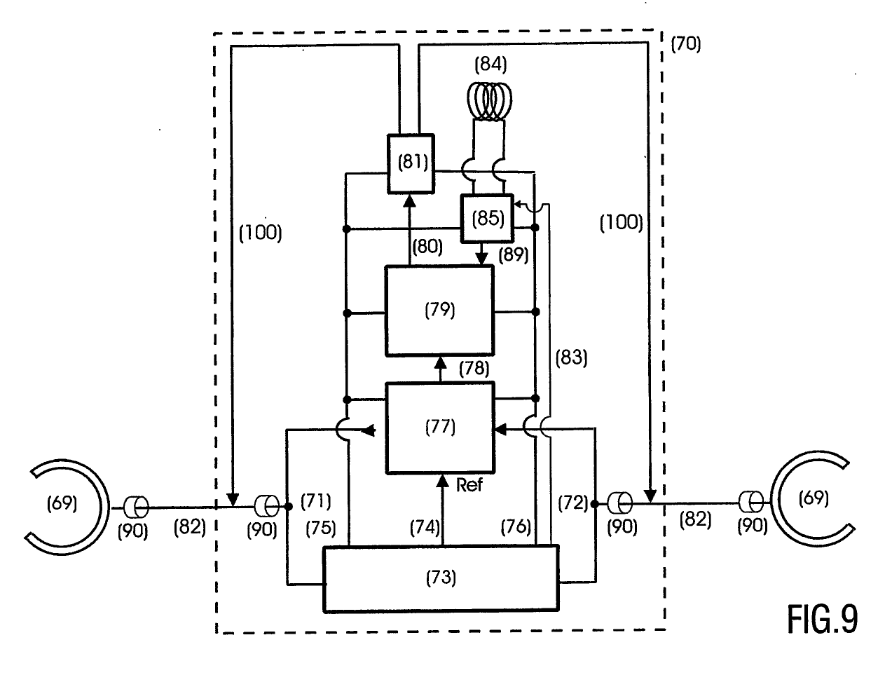

FIG. 9 shows a circuit diagram of a cell unit according to an exemplary embodiment of the present invention.

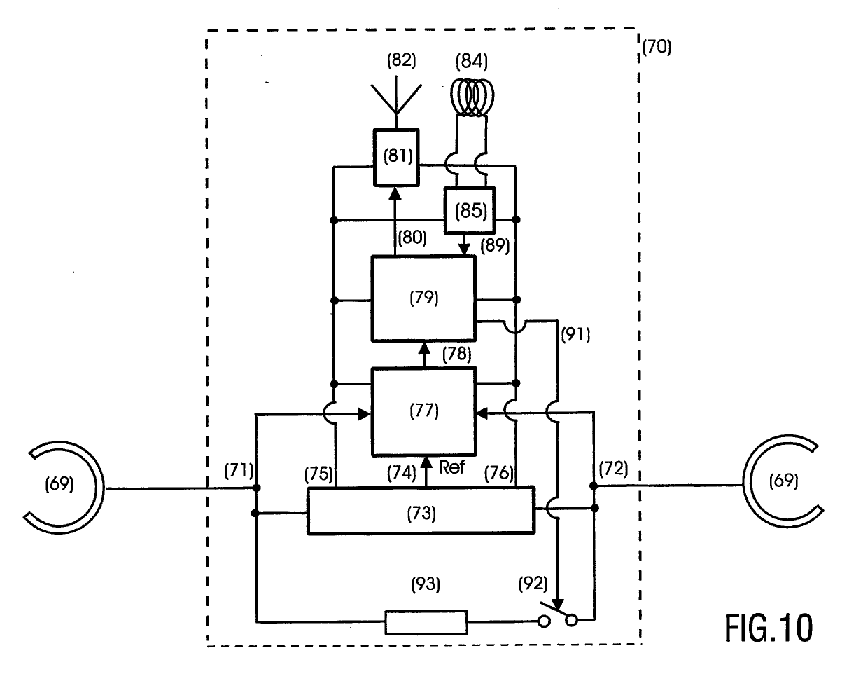

FIG. 10 shows a circuit diagram of a cell unit according to another exemplary embodiment of the present invention.

For the description of FIGS. 1-10, the same reference numerals are used to designate the same or corresponding elements.

FIG. 1 depicts a simplified schematic representation of the system for automated management of batteries according to an exemplary embodiment of the present invention. The upper part of two separate battery cells of a larger battery (not shown in FIG. 1) comprises electric poles 2. Connected to each of the poles 2 is a terminal post 3, which is electrically connected to an adjacent electric post 3 via an electric lead 4. Electric leads 4 and terminal posts 3 electrically connect the poles of adjacent battery cells 1. According to an aspect of the present invention, sensor terminals 6 are electrically connected to each pole of the battery cells and each respective pair of the sensor terminals 6 is electrically connected by a respective cell unit 5. In the particular embodiment depicted in FIG. 1, the terminals are secured to the poles of the battery cells by screws 7. However, any other form of appropriate mechanical means may also be used to secure the terminals 6 and 3 to the poles 2 of the battery cells, for example, poles, plugs or glue. The central unit 10, which communicates with the cell units, is depicted schematically. The central unit 10 comprises an antenna and a connection to a more advanced system, for example a computer. In addition, the battery cells comprise an opening 9 for refilling and maintaining the battery cells and a closing means 8, which provides a tight closing means for the opening 9.

FIG. 2 depicts a schematic representation of a battery 11, comprising twenty-four battery cells 12. Each battery cell comprises an opening for filling and maintaining the battery cell, which is tightly closed by a closing means 13. The poles of the battery cells are electrically connected to one another via terminal posts 14, such that the battery cells are serially connected.

The respective pairs of each battery cell are connected via cell units 16 and sensor terminals 15, as depicted in FIG. 2. Cell units 16 and sensor terminals 15 may comprise elastic leads, which may be bent in order to apply a mechanical force to the poles of the battery cells, which may lead to a low ohmic contact between the poles of the battery cells and the sensor terminals 15. As shown in FIG. 2, the sensors may be easily inserted between the poles of the battery cells, which allows for fast maintenance and exchange of sensors. The central unit 17 is positioned at a distance from the battery 11 and comprises an antenna for communicating with the cell units 16 via a wireless communication link.

FIG. 3 depicts different embodiments of the cell units and their respective terminals. Two battery cells 18 of a battery, each comprising electric poles 19 and electric leads 20, which connect the battery cells as depicted in FIG. 3. In addition, each battery cell comprises a hole for filling and maintaining the battery cell and, on top of the hole, a closing means 21, which provides for a tight sealing of the hole. The poles 19 of the right battery cell 18 comprise electric connectors 28, which are secured to the poles 19 of the battery cell 18 by means of screws 29. Cell unit 23 is connected to plugs 27 by means of flexible electric leads. Plugs 27 may be plugged onto electric connectors 28, thus providing electric contact between the poles 19 of the battery cell 18 and the cell unit 23.

Cell unit 22 is arranged on and part of terminal 25 and is electrically connected to plug 26 by means of a lead. Plug 26 is plugged into terminal 24. The two terminals 24 and 25 are adapted to tightly fit the poles 19 of battery cell 18, such that the whole assembly, comprising the two terminals 24 and 25, plug 26 and cell unit 22, maybe easily placed on top of battery cell 18 to provide electric contact between poles 19 and terminals 24 and 25, as indicated by the arrows shown in FIG. 3. It should be noted that it is also possible to use many other forms of providing an electric contact between poles 19 of battery cell 18 and cell units 22 and 23 and thus may be implemented in the present invention.

FIG. 4 depicts a schematic representation of an exemplary embodiment of the method for automated management of batteries according to the present invention. In that particular embodiment, the control unit is constructed in the form of a hand-held unit 30. It should be understood that the control unit 30 is not necessarily mobile, but may also be stationary. Nevertheless, a mobile solution for the control unit has the advantage for the user of being portable, which may lead to a more user-friendly operation. As depicted in FIG. 4, control unit 30 comprises an antenna 31, for transmitting control signals 36 to individual cell units 37 and an antenna 32 for receiving measured values 35 of the individual cell unit 37. Both antennas 31 and 32 operate in different frequency ranges, but it may also be possible to use only one antenna for both transmitting control signals 36 and receiving measured values 35. Connected to antennas 32 and 31 is a circuit 33 for providing control signals, which are transmitted to the cell unit 37 via antenna 31, for receiving measured values 35 from the cell unit 37 via antenna 32, for storing the received measured values 35 and for processing the received and stored measured values 35. Circuit 33 may comprise a micro-chip. For visualization of the measured and processed values, there is provided a display 34. It should be understood that the signals 35, which are transmitted from the cell unit 37 to the control unit 30 via a wireless communication link, may not only comprise measured values of the physical parameters of the battery cells such as the voltage at the poles, but also other types of information, such as serial numbers, battery cell specifications, the date, maintenance information, or specific information concerning the type of the individual battery cell. Battery 38 comprises a plurality of battery cells, which are serially connected by connectors 39. Each respective pair of poles of each battery cell is connected via a respective cell unit 37.

FIGS. 5a and 5b depict exemplary arrangements of cell units 40, 41 and 42, wherein the cell units 40, 41 and 42 connect groups of battery cells, the groups of battery cells comprising at least one battery cell. The advantage of connecting groups of battery cells by means of a cell unit 41 may be, amongst others, that by doing so, the particular cell unit 41 is driven with a higher voltage than in the case of a connection of respective poles of one single battery cell. Although groups of cells are connected by the cell units 40, 41 and 42, physical values of each single battery cell maybe calculated.

FIGS. 5a and 5b each depict a battery comprising six battery cells, A, B, C, D, E and F. Each respective pair of two adjacent battery cells (AB, BC, CD, DE, EF) is connected by means of a wireless cell unit 40. Furthermore, in FIG. 5a, a cell unit 41 is connected between respective poles of battery cells A and F, such that physical parameters between cells A and F can be measured.

Assuming that in the particular case depicted in FIGS. 5a and 5b, the physical parameters, which are measured by the cell units 40, 41 and 42, act like the voltage in a serial connection of battery cells. The measured value AB measured by the left cell unit 40 between battery cells A and B is calculated according to:
measured value AB=measured value of battery cell A+measured value of battery cell B.

The next cell unit 40 measures the value BC according to:
measured value BC=measured value of battery cell B+measured value of battery cell C.

Accordingly,
measured value CD=measured value of battery cell C+measured value of battery cell D
measured value DE=measured value of battery cell D+measured value of battery cell E
measured value EF=measured value of battery cell E+measured value of battery cell F

Cell unit 41 measures
measured value ABCDEF=measured value of battery cell A+ . . . +measured value of battery cell F.

By subtracting respective equations from each other, a value for each single battery cell may be calculated. This calculation may be carried out by means of a micro-chip, which is implemented in the system. The micro-chip for carrying out the calculation may be implemented in the control unit or in one of the cell units.

FIG. 5b depicts another assembly of cell units 40 and 42, wherein cell unit 42 is connected between the poles of battery cell A and battery cell C. Therefore, cell unit 42 measures a value according to:
measured value ABC=measured value of battery cell A+measured value of battery cell B+measured value of battery cell C.

Again, the value for each single battery cell may be calculated by simply subtracting respecting equations from each other. It may be seen as an advantage of the assembly depicted in FIG. 5b compared to the assembly depicted in FIG. 5a, that cell unit 42 is driven by a voltage which is not orders of magnitude greater than the voltages which drive each of cell units 40, but only a small factor, e.g. a factor 1,5 in FIG. 5b. Therefore, it may be possible to use the same design for cell units 40 and cell units 42.

FIG. 6 depicts a small cylindrical battery, comprising an appropriate antenna 46. The cylindrical battery cell comprises a cylindrical electrode 43 and two poles 44, one of them acting as anode and the other one acting as cathode. Connected to the poles 44 of the cylindrical battery cell are antenna 46 and cell unit 45. Antenna 46 is adapted in the form of a coil, which wraps around the cylindrical battery cell. The whole assembly is surrounded by an insulating coating 47, which can be penetrated by electromagnetic waves. The exemplary embodiment of the present invention depicted in FIG. 6, shows that it may even be possible to implement a cell unit according to the present invention in a single cylindrical battery cell.

FIG. 7 depicts a battery cell comprising a cell unit 56 according to an exemplary embodiment of the present invention. Electrodes 48 and 49 are adapted in form of metallic plates, facing each other without touching. Electrodes 49 are connected by means of connector 51 and electrodes 48 are connected by means of connector 50. Connector 50 is electrically connected to the positive pole 52 of the battery cell and connector 51 is electrically connected to the negative pole 53 of the battery cell. Both poles 52 and 53 are outside cell housing 57. Cell unit 56 is connected between poles 52 and 53 by means of metallic leads 54. According to this exemplary embodiment of the present invention, connectors 51 and 50, poles 53 and 52 and metallic leads 54 and 55 are made of the same material. Cell unit 56 may be surrounded by a housing, the housing comprising a material selected from the group consisting of plastic, glass or ceramics. Electric leads 54 do not touch each other, but are mechanically connected by the insulating housing of cell unit 56. Metallic leads 54 are adapted to form a dipole antenna and are terminated at their ends by inductivities 55. The inductive terminations 55 act as a low pass filter, which terminates high frequency ac currents but passes low frequency or dc currents.

Cell housing 57 is filled with an electrolyte 58, which may comprise a strong acid or basis. Therefore, all the electric parts, which are arranged inside housing 57, have to consist of or be surrounded by robust and chemically resistant materials.

FIG. 8 depicts a battery, comprising three battery cells, which are cylindrical in shape. The three cylindrical cells are surrounded by a housing 59, which houses the cylindrical cells. Each cylindrical cell comprises an anode and a cathode 61 and 64, respectively. Anodes 64 are electrically contacted to poles 65. The left main contact 60 of the battery is electrically connected to cathode 61 of the left battery cell and the right main electrode 60 is electrically connected to the pole 65 of the right battery cell. Pole 65 of the left battery cell is electrically connected to cathode 61 of the middle battery cell via electric lead 66. Pole 65 of the middle battery cell is electrically connected to cathode 61 of the right battery cell via electric lead 66, as depicted in FIG. 8. Each pole 65 of the three cylindrical battery cells is electrically connected to a respective cell unit 67. Each respective cell unit 67 is electrically connected to a respective cathode 61 via lead 68. Lead 68 is shaped in the form of a solenoid in such a way that it may be used as an antenna for low frequency electromagnetic fields. Cell unit 67 may be adapted in the form of an integrated circuit. Each battery cell is surrounded by a housing 62, which can be penetrated by electromagnetic waves. The interior region 63 of each battery cell is filled with an electrolyte.

FIG. 9 depicts a circuit diagram of a cell unit 70, which is electrically connected to the poles of a battery cell (not shown in FIG. 9) via sensor terminals 69. Leads 71 and 72 electrically connect sensor terminals 69 to a voltage source device 73 and to a measurement device 77. The voltage source device 73 provides a first reference voltage to the measurement device 77 via electrical lead 74. Furthermore, voltage source 73 may provide an A/D-conversion of the voltage between leads 71 and 72, which then may be used as first reference voltage. The reference voltage provided to the measurement device 77 may be used for the comparison of measured values with the reference voltage. Furthermore, the voltage source device 73 creates a stabilized driving voltage used for driving the measurement device 77, central processing unit 79 and transmitter 81 via electrical leads 75 and 76. The voltage source device 73 may also transform the driving voltage to voltages, which are different from the voltage provided by the poles of the battery cell. In addition, the voltage source device 73 may perform an AID conversion of the voltage, which is provided by measurement device 77, which measures physical parameters of the battery cell and transmits the measured values to central processing unit 79 via lead 78. Central processing unit 79 may save the measured values temporarily and process them. The processing of the measured values may comprise a subtraction of measured values, a combination of measured values, or any other form of operation.

For transmitting data to an external control unit (not shown), central processing unit 79 gives the data to transmitter 81 via lead 80. Transmitter 81 comprises an antenna 82, which can be used to broadcast the data to a control unit.

Voltage source device 73 may create a second reference voltage, which may be provided to device 85 via lead 83. Second reference voltage via lead 83 may be provided, as described above with respect to the first reference voltage via lead 74, in form of a digital signal created by voltage source 73.

According to another exemplary embodiment of the present invention, first and second reference voltages may be identical. In still another exemplary embodiment of the present invention, due to comparably slow changes of the measured values, the A/D-converter 73 may be operated in a multiplex mode.

Device 85 is connected to element 84, which may be a temperature sensor. This temperature sensor 84 may be used for measuring the temperature of an electrolyte inside a battery cell. The output of temperature sensor 84 may be a voltage, which is then compared to the second reference voltage by device 85. Comparison of the measured voltage of temperature sensor 84 and the second reference voltage may lead to a value which reflects the actual temperature of the electrolyte. This value is then transmitted to the central processing unit 79 via lead 89.

According to another exemplary embodiment of the present invention, sensor 84 may be adapted in the form of an antenna for receiving a wake-up signal from a control unit. Device 85 transmits the received wake-up signal to the central processing unit 79 via lead 89 in order to wake-up the sensor 70, which may have been put into a sleeping mode for energy saving reasons.

Antenna 82 for transmitting the measured values or the processed values to a control unit and for receiving control signals from the control unit may be integrated in leads 71 and 72. Decouplers 90 are arranged on leads 71 and 72 and may be adapted in form of ferrit beads or coils as depicted in FIG. 9, but any other form of low pass filter may be used. Decouplers 90 may be adapted to act as a low pass filter, which passes low frequency or dc currents, but blocks high frequency currents, which may be provided to antenna 82 by transmitter 81 via electric leads 100. Therefore, the frequency decouplers may act as a low pass filter and may enable the electrical leads to be used as dipole antenna for receiving signals from the control unit or for transmitting signals to the control unit.

Furthermore, the decouplers 90 may be adapted to convert high frequency electromagnetic radiation into electric energy. Advantageously, the decouplers 90 may receive electromagnetic waves, which may be transformed into electric energy. The electric energy may be used for driving the at least one cell unit.

FIG. 10 shows a circuit diagram of a cell unit, comprising a controllable contactor according to an exemplary embodiment of the present invention. The cell unit shown in FIG. 10 basically comprises the same elements and functions as the cell unit shown in FIG. 9. The central processing unit 79 is connected to controllable switching unit 92 via lead 91. Controllable switching unit 92 may be controlled by central processing unit 79 and may be adapted to adjust the current flowing between sensor terminals 69 via resistor 93. It should be understood that controllable switching unit 92 and resistor 93 may form one single component, e.g. a single electronic device, for controlling the current bypassing a battery cell. By means of the controllable switching unit 92, a short circuit may be provided between two poles of battery cells inside a battery. Therefore controllable switching unit 92 may be adapted in form of a high current switch, which may be a thyristor or a field effect transistor, for bypassing one or more battery cells.

The controllable switching unit 92 may be adapted to perform a charge balancing such that the charging of each battery cell of the plurality of battery cells is adjusted according to a mean charging value. In other words, in case the battery drives an external consumer and the cell units detect a different charging of the battery cells, a charge balancing between each battery cell may be performed, meaning that a battery cell with a lower charging is disconnected from the external consumer until it's charging reaches a mean charging value. This mean charging value may be the mean charging value of all battery cells of the battery.

Also charges of a plurality of battery cells may be balanced that each of the battery cells has the same charging state or charge. As mentioned above, this may be accomplished by temporarily establishing respective controllable current paths between poles of the battery cells.

It should be noted that, according to the present invention, physical properties which may be measured or influenced by the cell units depicted in FIGS. 1-10 may include:
a) dc voltage between the poles of the battery cells with or without high ohmic working resistance;
b) dc voltage for a working cell during an ordinary charging or discharging cycle of a cell or during high current flow;
c) dc voltage for a working cell with set current flow;
d) dc voltage at particular times of a charging/discharging cycle or of a regeneration cycle;
e) time for obtaining a reference voltage or for passing through a reference voltage interval;
f) voltage drop, current or resistance during feeding a cell or a group of cells with an external voltage source or current source in order to measure physical properties of a cell;
g) ac voltage during application of an ac voltage/ac current to the whole battery;
h) physical properties of c), d), e) or f), but with use of alternating values with constant or variable frequency or with a plurality of different frequencies;
i) temperature of e.g. electrolyte or electrodes of a battery cell;
j) fill level of electrolyte or density of electrolyte;
k) pressure inside a battery cell;
l) number of opening events of excess pressure valves or recording of length of opening;
m) dielectric constant of the electrolyte;
n) gas concentration above the electrolyte inside a battery cell;
o) generation of gas bubbles and boiling of the electrolyte;
p) sound generation by generation of gas bubbles or chemical recombination of gases;
q) changes in colour or light absorption coefficient of the electrolyte;
r) mass deposited on electrodes;
s) deposition on bottom of a battery cell or on the walls;
t) changes in viscosity of viscose or gel electrolytes;
u) overall mass of a battery cell;
v) temperature, conductivity, humidity and other electrical measurable physical properties of a chemical catalyst used for recombining gases generated in a battery cell;
w) deformation of walls of a battery cell or other parts of the battery cell, e.g. deformation sensors, in order to detect an increase of pressure or temperature inside the battery cell;
x) radiation inside or outside of a battery cell, e.g. in case of a radioactive marling of the electrochemically active parts of the cell in order to record their temporal distribution;
y) cell current, particularly in case of charge balancing of parallel battery cells;
z) many other physical parameters of a battery cell or a group of battery cells.

1. System for automated management of batteries, the batteries comprising at least one battery cell, the system comprising: at least one cell unit for measuring physical parameters of the at least one battery cell; a control unit; and a transmitter for transmitting the measured values of the physical parameters to the control unit via a first wireless communication link.

2. System according to claim 1, wherein the control unit comprises a control unit transmitter for transmitting control signals to the at least one cell unit via a second wireless communication link.

3. System according to claim 2, wherein a switching unit is provided; and wherein the switching unit is adapted for temporarily establishing a controllable current path between poles of the at least one battery cell.

4. System according to claim 2, wherein a battery comprises a plurality of battery cells, and wherein the switching unit is adapted to perform a charge balancing such that charging states of the plurality of battery cells adjusted to each other.

5. System according to claim 2, wherein the at least one cell unit is at least partially disposed in an interior region of the at least one battery cell for providing direct contact to an electrolyte of the at least one battery cell; and wherein the at least one cell unit is at least partially surrounded by robust and chemically resistant material.

6. System according to claim 2, comprising a communication link between the cell units for direct communication with one another.

7. System according to claim 2, wherein the at least one cell unit comprises at least one of: electric leads; a storage; and a controllable rectifier; wherein the electric leads comprise high frequency decouplers for converting high frequency electromagnetic radiation into electric energy; wherein the storage is adapted for storing electric energy, and wherein the controllable rectifier is adapted for controlling the charging of the at least one battery cell.

8. Cell unit for measuring physical parameters of battery cells, the cell unit comprising a cell unit transmitter for a transmission of the measured values of physical parameters of the battery cells via a wireless communication link.

9. Cell unit according to claim 8, wherein a switching unit is provided; and wherein the switching unit is adapted to perform a charge balancing such that the charging states of the battery cells are adjusted to each other.

10. Cell unit according to claim 9, comprising at least one of: electric leads; a storage; and a controllable rectifier; wherein the electric leads comprise high frequency decouplers for converting high frequency electromagnetic radiation into electric energy; wherein the storage is adapted for storing electric energy; and wherein the controllable rectifier is adapted for controlling the charging of the battery cells.

11. Control unit for receiving measured values of physical parameters of battery cells, the control unit comprising a control unit transmitter for transmitting control signals to a cell unit; wherein the measured values are received via a first wireless communication link; and wherein the control signals are transmitted via a second wireless communication link.

12. Control unit according to claim 11, wherein the control signals provide synchronization information to the cell unit.

13. Control unit according to claim 11, wherein the control unit addresses each cell unit individually; wherein the control unit initiates the measurement of the physical parameters of the battery cells; wherein the control unit requests the transmission of measured values of the physical parameters.

14. Method for automated management of batteries, the batteries comprising at least one battery cell, the method comprising the steps of: measuring of physical parameters of the at least one battery cell by at least one cell unit; transmitting the measured values of the physical parameters via a first wireless communication link to a control unit.

15. Method according to claim 14, further comprising the steps of: individually controlling a charge of the at least one battery cell; transmitting individual control signals from the control unit to the at least one cell unit via a second wireless communication link.

16. Method according to claim 14, wherein each cell unit measures the physical parameters of a respective group of battery cells, the groups comprising at least one battery cell; wherein each battery cell belongs to at least two groups; wherein the measured values of the physical parameters of particular groups are subtracted from one another or otherwise processed for obtaining the physical parameters of individual battery cells.

17. Method according to claim 14, wherein a density or a fill level of electrolyte in the at least one battery cell is measured by detecting a change in an emitted electromagnetic signal.

18. Method according to claim 15, wherein signals are transmitted by at least one technique selected from the group consisting of: transmission of electromagnetic waves, inductive transmission, transmission of light, transmission of sound, and transmission of ac currents.

19. Method according to claim 14, wherein a charge balancing is performed to adapt charges of a plurality of battery cells to each other by temporarily establishing a current path between poles of the plurality of battery cells.
